(19) United States
(12) Patent Application Publication
(10) Pub. No.: US 2014/0379470 A1
(43) Pub. Date: Dec. 25, 2014

(54) METHOD AND SYSTEM FOR LINKING MOBILE DATA AND TRANSACTION DATA FOR IMPROVED LOCATION BASED TARGETING

(71) Applicant: MasterCard International Incorporated, Purchase, NY (US)

(72) Inventor: Rohit CHAUHAN, Somers, NY (US)

(73) Assignee: MASTERCARD INTERNATIONAL INCORPORATED, Purchase, NY (US)

(21) Appl. No.: 14/310,424

(22) Filed: Jun. 20, 2014

Related U.S. Application Data
(60) Provisional application No. 61/837,806, filed on Jun. 21, 2013.

(51) Int. Cl. G06Q 30/02

(52) U.S. Cl. CPC G06Q 30/0255; G06Q 30/0261; G06Q 30/0267
USPC 705/14.53

(57) ABSTRACT

A method for assigning a spend profile to a mobile device based on location and transaction data includes: storing a spend profile including a plurality of transaction data entries, each entry related to a transaction involving a common consumer and including a location identifier, transaction data, and timing information; receiving a plurality of location data entries, each entry including a geographic location of a related mobile device and a time and/or date at which the location was identified; matching the mobile device to the spend profile based on a number of received location data entries that correspond to transaction data entries included in the spend profile based on the geographic location and time and/or date and the location identifier and timing information, and a predetermined tolerance level; and associating the mobile device with the spend profile.

### FIELD

The present disclosure relates to the assignment of a spend profile to a mobile device, specifically assigning a spend profile to a mobile device based on mobile location data and transaction data not associated with the mobile device.

### BACKGROUND

With the increase of use of mobile communication devices, such as smartphones, merchants, retailers, offer providers, and other entities have an increased desire to advertise, distribute offers, or otherwise push content to these mobile devices. Some methods for distributing content to mobile devices include using geolocation to transmit content to a mobile device based on their location, such as by distributing an advertisement or offer for a nearby merchant to the mobile device. However, these methods provide content to all mobile devices in the specified area, without regard for preferences of the user, which may result in a low success rate.

In order to provide more suitable content, some methods have been developed for associating a mobile device with a credit card, and distributing content to the mobile device based on a combination of the purchase history of the credit card and the mobile device's current location. However, such methods rely on the purchase history of the individual consumer with regard to a single payment account, which does not take into account additional purchases made using other accounts or payment methods, such as cash purchases. Furthermore, such methods may present a privacy issues for consumers that do not wish to personal identify their mobile device as associated with their account information.

Thus, there is a need for a technical solution for identifying a profile to be associated with a mobile device for the distribution of content to the mobile device based on historical transaction and location data, without regard for the mobile device user's personal transaction history or payment methods.

### SUMMARY

The present disclosure provides a description of a system and method for the assigning of a spend profile to a mobile device based on location and transaction data.

A method for assigning a spend profile to a mobile device based on location and transaction data includes: storing, in a profile database, at least one spend profile, wherein each of the at least one spend profile includes a plurality of transaction data entries, each transaction data entry including data related to a payment transaction involving a common consumer and including at least a location identifier, transaction data, and timing information; receiving, by a receiving device, a plurality of location data entries, wherein each location data entry includes data related to a mobile communication device and includes at least a geographic location of the related mobile communication device and a time and/or date at which the corresponding geographic location of the related mobile communication device was identified; matching, by a processing device, the mobile communication device to a specific spend profile of the at least one spend profile based on a number of received location data entries that correspond to transaction data entries included in the specific spend profile based on the geographic location and time and/or date included in the corresponding location data entry and the location identifier and timing information included in the corresponding transaction data entry, and a predetermined tolerance level; and associating, in a mobile information database, the mobile communication device with the specific spend profile.

A system for assigning a spend profile to a mobile device based on location and transaction data includes a mobile information database, a profile database, a receiving device, and a processing device. The profile database is configured to store at least one spend profile, wherein each of the at least one spend profile includes a plurality of transaction data entries, each transaction data entry including data related to a payment transaction involving a common consumer and including at least a location identifier, transaction data, and timing information. The receiving device is configured to receive a plurality of location data entries, wherein each location data entry includes data related to a mobile communication device and includes at least a geographic location of the related mobile communication device and a time and/or date at which the corresponding geographic location of the related mobile communication device was identified. The processing device is configured to: match the mobile communication device to a specific spend profile of the at least one spend profile based on a number of received location data entries that correspond to transaction data entries included in the specific spend profile based on the geographic location and time and/or date included in the corresponding location data entry and the location identifier and timing information included in the corresponding transaction data entry, and a predetermined tolerance level; and associate, in the mobile information database, the mobile communication device with the specific spend profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A and 1B are a high level architecture illustrating a system for the assignment of a spend profile to a mobile device based on location data and transaction data in accordance with exemplary embodiments.

FIG. 2 is a block diagram illustrating the processing server of FIG. 1 for the generating and assigning of spend profiles in accordance with exemplary embodiments.

FIG. 3 is a block diagram illustrating the profile database of FIG. 2 for storing spend profile data in accordance with exemplary embodiments.

FIG. 4 is a flow chart illustrating a method for generating a spend profile based on transaction data in accordance with exemplary embodiments.

FIG. 5 is a diagram illustrating the matching of a mobile device to a spend profile based on transaction and location data in accordance with exemplary embodiments.

FIG. 6 is a flow chart illustrating a method for assigning a spend profile to a mobile device based on location and transaction data in accordance with exemplary embodiments.

FIG. 7 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Assigning a Spend Profile to a Mobile Device

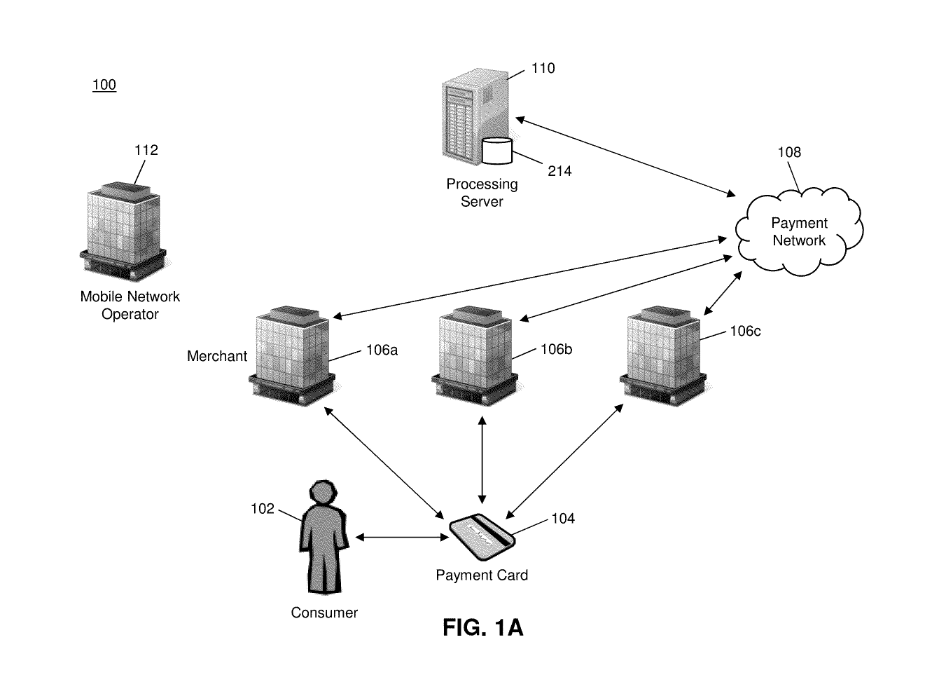

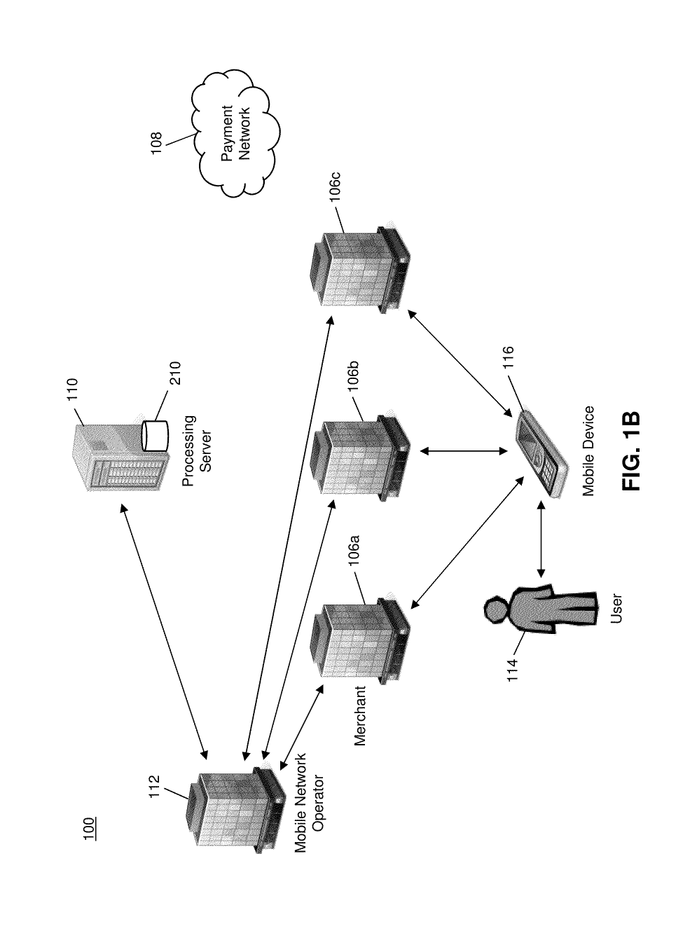

FIGS. 1A and 1B illustrates a system 100 for assigning a spend profile to a mobile communication device based on transaction and location data.

The system 100 may include a consumer 102. The consumer 102 may have a payment card 104 associated with the consumer 102, such as a payment card issued to the consumer 102 by an issuer (e.g., an issuing bank) as associated with a payment account of the consumer 102 and held by the issuer. The consumer 102 may engage in financial transactions with a plurality of merchants 106, such as merchants 106a, 106b, and 106c illustrated in FIG. 1A. As part of the financial transactions, the consumer 102 may present the payment card 104 for payment.

Each of the merchants 106 may process the financial transactions using methods that will be apparent to persons having skill in the relevant art, such as by submitting authorization requests to (e.g., via an acquirer, such as an acquiring bank) a payment network 108 for processing. The payment network 108 may process the financial transaction using methods that will be apparent to persons having skill in the relevant art. After the transaction has been completed, the payment network 108 may provide transaction data for each of the financial transactions to a processing server 110. The processing server 110, discussed in more detail below, may store the transaction data in a payment database 214, also discussed in more detail below.

As illustrated in FIG. 1B, the system may also include a user 114 of a mobile device 116. In an exemplary embodiment, the user 114 is not the consumer 102 and may not have authorization to use the payment card 104 or otherwise have access to the payment accounts associated with the payment card 104 or the consumer 102. The mobile device 116 may be any type of mobile communication device suitable for performing the functions as disclosed herein, such as a cell phone, smart phone, tablet computer, notebook computer, laptop computer, etc. The user 114 may visit locations for each of the merchants 106a, 106b, and 106c while in possession of the mobile device 116. A mobile network operator 112 may be configured to identify the geographic location of the mobile device 116, and may thereby identify the mobile device 116 being located at each of the merchants 106a, 106b, and 106c.

The mobile network operator 112 may be any type of entity or service configured to identify the geographic location of a mobile device using methods that will be apparent to persons having skill in the relevant art. For example, the geographic location of the mobile device 116 may be identified via a geographic positioning system, cellular network triangulation, WiFi, local area network identification, etc., which may be performed by the mobile network operator 112 or the mobile device itself and then transmitted to the mobile network operator 112. The mobile device 116 may periodically report its location directly to the processing server 110 or through an intermediary third party, either alternatively or in addition to the service provided by the mobile network operator 112. The frequency of the location reporting depends on circumstances, such as region, estimated speed of travel, availability of resources, requirements of the user, advertisers or other parties to the overall purpose and process, etc.

The mobile network operator 112 may transmit the location data of the mobile device 116 to the processing server 110. The processing server 110, discussed in more detail below, may store the received location data in a mobile information database 210. In some embodiments, the processing server 110 may be included as part of the payment network 108, and may be further configured to perform the functions of the payment network 108. For example, the processing server 110 may be configured to process payment transactions, and may be configured to store transaction data for the processed payment transactions in the payment database 214, for use in performing the functions as disclosed herein.

In other embodiments, the processing server 110 may be a part of the mobile network operator 112, or may be configured to receive the geographic locations and/or location data of the mobile device 116 directly from the mobile device 116. Other suitable configurations of the system 100 will be apparent to persons having skill in the relevant art. After receiving the transaction and location data, the processing server 110 may then identify a spend profile to be associated with the mobile device 116 based on the transaction and location data, via methods discussed in more detail below.

Processing Server

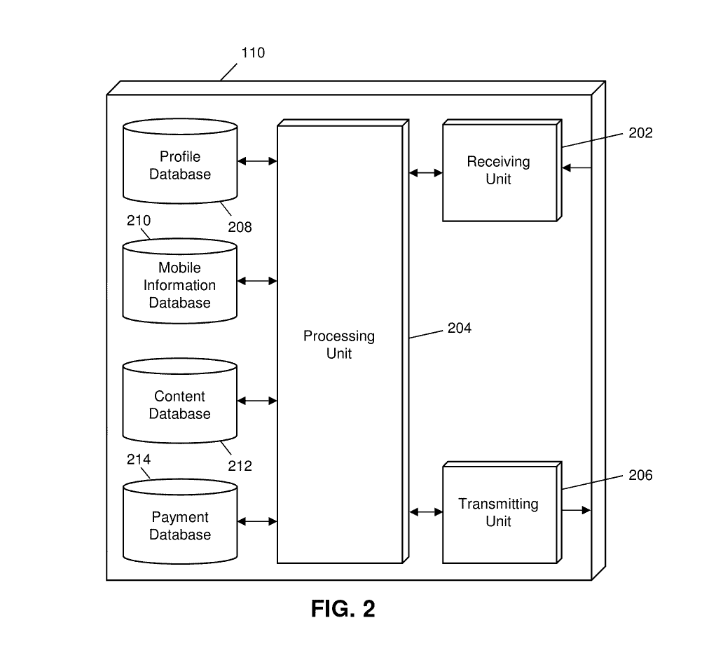

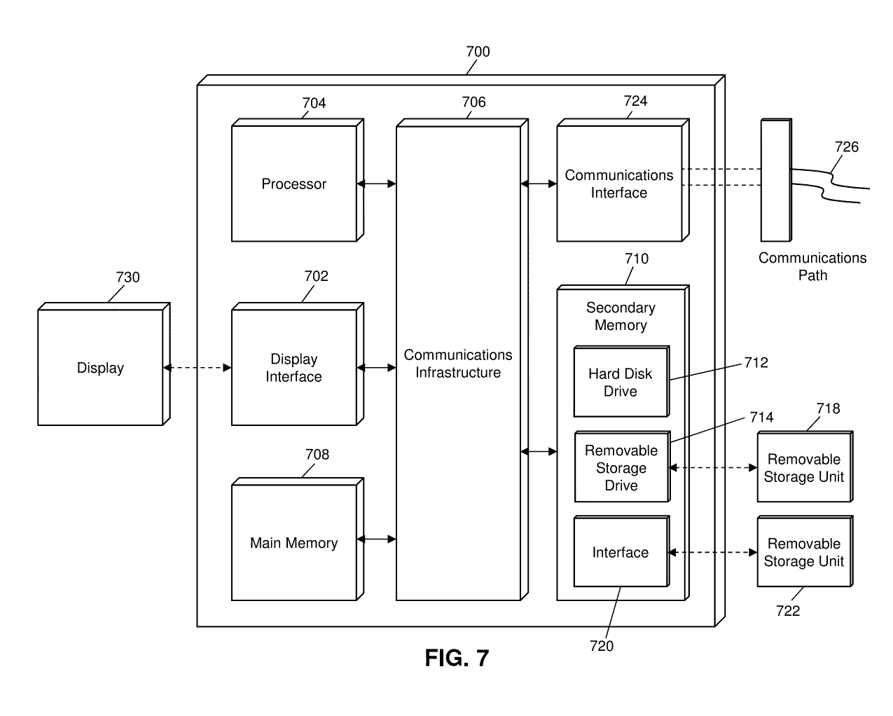

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 700 illustrated in FIG. 7 and discussed in more detail below may be a suitable configuration of the processing server 110.

The processing server 110 may include a receiving unit 202. The receiving unit 202 may be configured to receive data from one or more networks (e.g., the Internet) via one or more network protocols (e.g., Internet Protocol), such as transaction data transmitted to the processing server 110 by the payment network 108 and location data transmitted to the processing server by the mobile network operator 112 and/or the mobile device 116. The processing server 110 may also include a processing unit 204, which may be configured to store the received location data in the mobile information database 210 and the transaction data in the payment database 214.

The payment database 214 may be configured to store a plurality of payment data entries corresponding to the transaction data for the financial transactions, received from the payment network 108. Each payment data entry may include at least a consumer identifier. The consumer identifier may be a unique value associated with a consumer (e.g., the consumer 102) used for identification, and may be included in the authorization request for the corresponding financial transaction. For example, the consumer identifier may be a payment account number associated with the payment account used to fund the financial transaction. Each payment data entry may further include a location identifier, timing information, and transaction data, discussed in more detail below.

As discussed in more detail below, the processing unit 204 may be configured to identify at least one spend profile based on the transaction data stored in the payment database 214. The processing unit 204 may be further configured to store the identified at least one spend profile in a profile database 208, discussed in more detail below. The processing unit 204 may then match the mobile device 116 to a spend profile stored in the profile database based on the transaction data included in the spend profile and the location data corresponding to the mobile device 116 and stored in the mobile information database 210. Data included in the location data will be discussed in more detail below with respect to the matching of the mobile device 116 to a spend profile.

The processing server 110 may also include a content database 212. The content database may be configured to store a plurality of content items, such as offers, coupons, rewards, discounts, promotions, advertisements, etc. In some embodiments, each of the content items may be associated with one or more profile characteristics, such as spend behavior, propensity to spend, merchant preferences, geographic preferences, industry preferences, transaction frequency, etc. The processing unit 204 may be configured to identify one or more content items based on the associated profile characteristics and characteristics associated with the spend profile associated with the mobile device 116. The processing server 110 may include a transmitting unit 206, which may be configured to transmit the identified content item or items to the mobile device 116 using methods that will be apparent to persons having skill in the relevant art, such as short message service (SMS) message, multimedia message service (MMS) message, e-mail, via an application program, etc.

### Spend Profiles

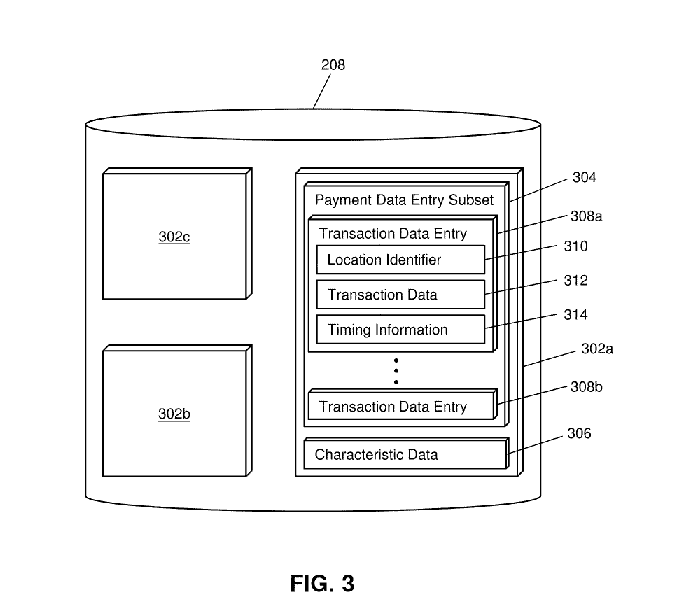

FIG. 3 is an illustration of the profile database 208 of the processing server 110. The profile database 208 may store a plurality of spend profiles 302, illustrated as spend profiles 302a, 302b, and 302c. Each spend profile 302 may include a payment data entry subset 304 and characteristic data 306. It will be apparent to persons having skill in the relevant art that each spend profile 302 may include multiple payment data entry subsets 304, which may correspond to multiple consumers 102 being associated with the specific spend profile 302, as discussed in more detail below.

Each payment data entry subset 304 may include a plurality of transaction data entries 308, illustrated as transaction data entries 308a and 308b. Each transaction data entry 308 in a particular payment data entry subset 304 may be related to payment transactions including a common consumer 102 or payment account, such as based on consumer identifiers included in the authorization requests of the corresponding payment transactions. Each transaction data entry 308 may include at least a location identifier 310, transaction data 312, and timing information 314.

The location identifier 310 may be a value indicative of a geographic location at which the corresponding financial transaction took place. In some instances, the location identifier 310 may be a representation of the geographic location, such as an address, latitude and longitude, etc. In other instances, the location identifier 310 may be a merchant identifier or other value, which may be used by the processing server 110 to identify the geographic location. For example, the location identifier 310 may be an identifier corresponding to a specific point-of-sale which was used to submit the authorization request for the transaction, which the processing server 110 may use to identify the geographic location, such as via a look-up table.

The transaction data 312 may be additional data associated with the related payment transaction, such as transaction amount, product details, merchant name, merchant identifier, merchant industry, payment method, etc. Data included in the transaction data 312 may vary based on application and situation as will be apparent to persons having skill in the relevant art as discussed in more detail below.

The timing information 314 may include information with regard to the time at which the related payment transaction took place. For example the timing information may include the time and/or date at which the payment transaction was initiated, processed, cleared, etc., may include the time elapsed since a previous payment transaction involving the same consumer 102 and/or payment account (e.g., such as the most recent overall transaction, most recent transaction with the same merchant, most recent transaction at the same transaction amount, etc.), or may include any other suitable information as will be apparent to persons having skill in the relevant art.

The characteristic data 306 included in each spend profile 302 may include data and values used for the distribution of content to mobile devices associated with the corresponding spend profile. The characteristic data 306 may include spend behaviors, propensity to spend, merchant preferences, geographic preferences, industry preferences, transaction frequency, demographic information, payment method preferences, or any other suitable information. The characteristic data 306 may be identified by the processing server 110 (e.g., by the processing unit 204) based on the information included in each transaction data entry 308 included in each of the payment data entry subsets 304 of the spend profile 302.

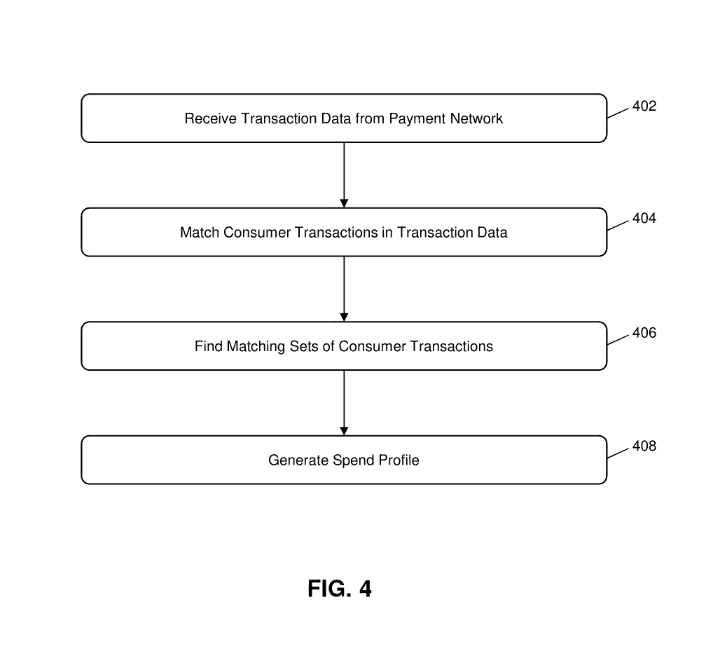

FIG. 4 illustrates a method for generating spend profiles 302. It will be apparent to persons having skill in the relevant art that the method illustrated in FIG. 4 is provided as an illustration only, and that additional methods suitable for generating spend profiles based on transaction data for one or more consumers will be apparent to those persons.

In step 402, the processing server 110 may receive transaction data from the payment network 108, which may be stored in the payment database 214. The transaction data may include payment data entries including data related to payment transactions involving a plurality of consumers, and may include at least a consumer identifier, a location identifier 310, transaction data 312, and timing information 314 for each payment transaction. In step 404, the processing server 110 may match consumer transactions included in the transaction data, such as by identifying a plurality of payment data entry subsets 304, wherein each payment data entry subset 304 includes each payment data entry stored in the payment database 214 involving a common consumer identifier. That is to say, each payment data entry subset 304 may include each transaction involving a particular consumer 102 and/or payment account.

In step 406, the processing unit 204 may identify matching sets of consumer transactions by identifying matching groups of payment data entry subsets 304 based on the included location identifiers 310, transaction data 312, and/or timing information 314. In an exemplary embodiment, payment data entry subsets 304 may be grouped together based on common transaction history for each of the corresponding consumers. For example, the processing unit 204 may group together the payment data entry subsets 304 for those consumers that go to the same restaurant for lunch and to the same grocery store afterwards in the same timeframe, for consumers that visit the same stores in a shopping mall for the same length of time, shop at the same combination of stores, follow the same shopping routine, spend the same amount at specific stores, etc. Methods for matching payment data entry subsets 304 to form groups based on the data included therein will be apparent to persons having skill in the relevant art. See, for example, U.S. Application No. 20130024242, “Protecting Privacy in Audience Creation” by Villars, et al, herein incorporated by reference.

In step 408, the processing unit 204 may generate a spend profile 302 for each matched group of payment data entry subsets 304. Generating the spend profile 302 may include generating the characteristic data 306 to be included in the spend profile 302 based on the information included in the transaction data entries 308 in one or more of the payment data entry subsets 304 included in the corresponding group. In some embodiments, the spend profile 302 may be generated using a single representative payment data entry subset 304. The processing unit 204 may store the generated spend profile 302 in the profile database 208, and may include each payment data entry subset 304 in the corresponding group, may include a single representative payment data entry subset 304, or may generate a single payment data entry subset 304 to be included in the spend profile 302 that is representative of each payment data entry subset 304 in the group based on the data included therein. Methods for generating a representative payment data entry subset 304 will be apparent to persons having skill in the relevant art.

### Assigning a Spend Profile to a Mobile Device Based on Location Data

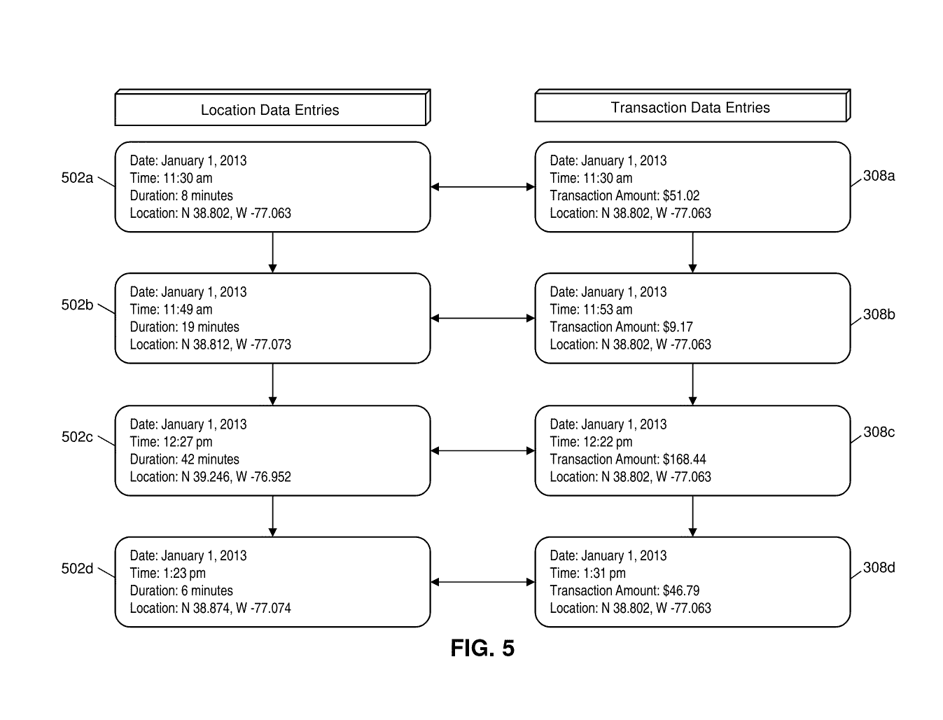

FIG. 5 illustrates a method for assigning a spend profile 302 generated based on transaction data for a plurality of consumers 102 to a mobile device 116 associated with a user 114. In an exemplary embodiment, the user 114 may not be associated with any consumer 102 whose transaction data was included in the assigned spend profile 302. In such an instance, a spend profile 302 may be assigned to a user 114 and/or mobile device 116 without obtaining any transaction data or other potentially personally identifiable data on the user 114.

As illustrated in FIG. 5, a plurality of location data entries 502 corresponding to the mobile device 116, illustrated as location data entries 502a, 502b, 502c, and 502d, may be matched to transaction data entries 308 included in a specific spend profile 302. Each location data entry 502 may include at least a geographic location of the corresponding mobile device 116 and a time and/or date at which the geographic location of the mobile device 116 was identified. In some embodiments, the time and/or date may also include a duration representing the length of time that the mobile device 116 remained at the geographic location.

The processing unit 204 may match the location data entries 502 to the transaction data entries 308 based on the included information. For example, as illustrated in FIG. 5, location data entry 502a may be matched to transaction data entry 308a, where the mobile device 116 was at the same geographic location at close to the same time as a payment transaction was processed for the corresponding consumer 102. After departing from the location corresponding to the location data entry 502a, the user 114 was identified at the geographic location corresponding to the location data entry 502b. The processing unit 204 may identify this as corresponding to the transaction data entry 308b, which corresponds to a payment transaction that occurred at the same geographic location shortly after the user 114 arrived at the location. The processing unit 204 may identify similar matching of the location data entries 502c and 502d, and the transaction data entries 308c and 308d, respectively.

In an exemplary embodiment, the matching of the location data entries 502 corresponding to the location data of the mobile device 116 to the transaction data entries 308 of a specific spend profile 302 may be additionally based on a predetermined tolerance level. The predetermined tolerance level may indicative of a tolerance accepted by the processing unit 204 for matching the mobile device 116 to a spend profile 302 when the location data entries 502 do not directly correspond to the transaction data entries 308. The location history for the mobile device 116 may rarely directly correspond to the transaction history for a specific spend profile 302, and thus the predetermined tolerance level may be used to provide for a match between the mobile device 116 and the spend profile 302. In some instances, the predetermined tolerance level may provide for tolerance in timing (e.g., different times of day, different durations, different time between visits/transactions, different days of the week, etc.), location (e.g., due to level of detail of location measurements), etc.

In other instances, the predetermined tolerance level may provide for tolerance in the number of location data entries 502 to be matched to the transaction data entries 308, or a combination thereof. For example, the location history of the mobile device 116 may indicate that the user 114 visited five clothing stores in a shopping mall at specific times, while the transaction history for a specific spend profile 302 may indicate the consumer 102 making purchases at only four of the same clothing stores, but on a similar timeframe. The mobile device 116 may still be matched to the specific spend profile 302 based on the predetermined tolerance level, which may take into account the fact that the consumers 102 associated with the specific spend profile 302 may have visited the fifth clothing store similar to the user 114, but may have not made a purchase. Similarly, the user 114 may be matched to a spend profile 302 in an instance where the user 114 only visited four stores despite the spend profile 302 indicating purchases at five stores, as the user 114 may have merely been finished shopping after the four stores or had to cut their shopping short due to a previous engagement.

The predetermined tolerance level may thus be used to implement inferred match methodology or “fuzzy matching” such that mobile devices 116 may be matched to spend profiles 302 despite differences in the matching of the location history to the transaction history, as discussed above. The tolerance that may be accepted in differences between the two histories may vary depending on the size of the history, the type of differences, content to be distributed, and additional factors as will be apparent to persons having skill in the relevant art.

### Exemplary Method for Assigning a Spend Profile to a Mobile Device Based on Location and Transaction Data

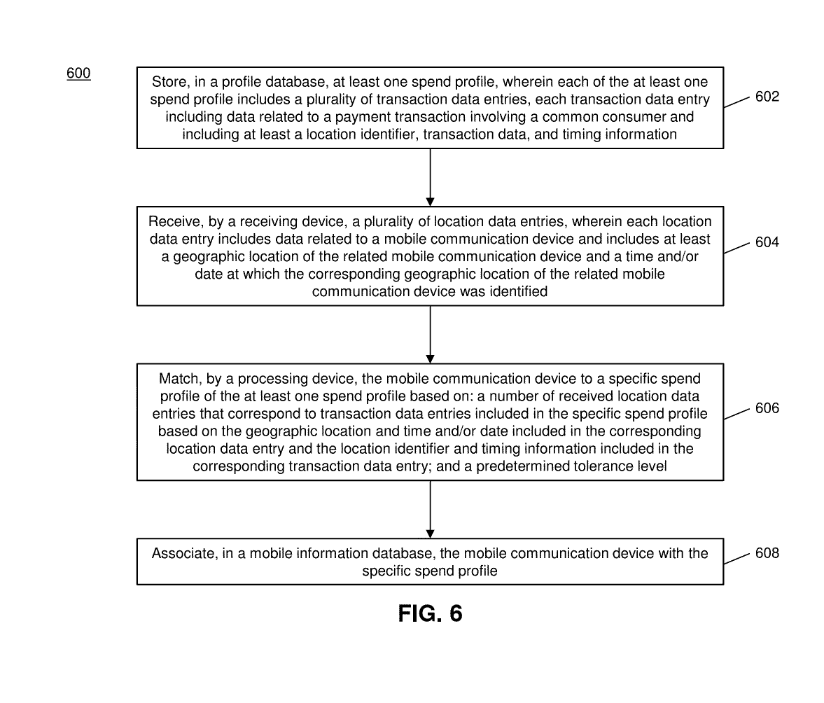

FIG. 6 illustrates an exemplary method 600 for assigning a spend profile (e.g., the spend profile 302) to a mobile device (e.g., the mobile device 116) based on location and transaction data.

In step 602, at least one spend profile 302 may be stored in a profile database (e.g., the profile database 208), wherein each of the at least one spend profile 302 includes a plurality of transaction data entries (e.g., transaction data entries 308), each transaction data entry 308 including data related to a payment transaction involving a common consumer (e.g., the consumer 102) and including at least a location identifier (e.g., the location identifier 310), transaction data (e.g., the transaction data 312), and timing information (e.g., the timing information 314). In one embodiment, the transaction data 312 may include at least one of: merchant name, merchant category, merchant identifier, transaction amount, product data, and payment method. In some embodiments, each spend profile may further include a plurality of characteristics (e.g., characteristic data 306) based on at least the transaction data 312 included in each of the plurality of transaction data entries 308 included in the corresponding spend profile 302.

In a further embodiment, the plurality of characteristics may include at least one of: spend behavior, propensity to spend, merchant preferences, geographic preferences, industry preferences, and transaction frequency. In another further embodiment, the method 600 may further include: storing, in a content database (e.g., the content database 212), wherein each content items is associated with a profile characteristic; identifying, by the processing device 204, at least one content item of the plurality of content items where the associated profile characteristic is included in the plurality of characteristics 306 included in the specific spend profile 302; and transmitting, by a transmitting device 206, the at least one content item to the mobile communication device 116.

In step 604, a plurality of location data entries (e.g., the location data entries 502), may be received, by a receiving device (e.g., the receiving unit 202), wherein each location data entry 502 includes data related to a mobile communication device 116 and includes at least a geographic location of the related mobile communication device 116 and a time and/or date at which the corresponding geographic location of the related mobile communication device 116 was identified.

In step 606, a processing device (e.g., the processing unit 204) may match the mobile communication device 116 to a specific spend profile 302 of the at least one spend profile 302 based on: a number of received location data entries 502 that correspond to transaction data entries 308 included in the specific spend profile 302 based on the geographic location and time and/or date included in the corresponding location data entry 502 and the location identifier 310 and timing identifier 314 included in the corresponding transaction data entry 308; and a predetermined tolerance level.

In step 608, the mobile communication device 116 may be associated, in a mobile information database (e.g., the mobile information database 210), with the specific spend profile 302. In one embodiment, the method 600 may further include identifying, by the processing device 204, at least one content item associated with the specific spend profile, and transmitting, by a transmitting device (e.g., the transmitting unit 206), the at least one content item to the mobile communication device 116. In a further embodiment, the at least one content item is one of: an offer, a coupon, a reward, an advertisement, a discount, and a promotion.

In another embodiment, the method 600 may further include: storing, in a payment database (e.g., the payment database 214), a plurality of payment data entries, wherein each payment data entry includes data related to a payment transaction including at least a consumer identifier, a location identifier 310, timing information 314, and transaction data 312; identifying, by the processing device 204, a plurality of payment data entry subsets (e.g., the payment data entry subset 304), wherein each payment data entry subset 304 includes each payment data entry of the plurality of payment data entries including a common consumer identifier; identifying, by the processing device 204, a group of payment data entry subsets 304 based on common location identifiers 310 and timing information 314 included in the plurality of payment data entries included in each payment data entry subset 304 of the group of payment data entry subsets 304; and storing, in the profile database 208, the group of payment data entry subsets 304 as a spend profile 302, wherein the plurality of transaction data entries 308 includes at least one payment data entry subset 304 included in the group of payment data entry subsets 304. In a further embodiment, the group of payment data entry subsets 304 may be further based on common transaction data 312 included in the plurality of payment data entries included in each payment data entry subset 304 of the group of payment data entry subsets 304. In an even further embodiment, the common transaction data 312 may include at least one of: transaction amount and product data.

### Computer System Architecture

FIG. 7 illustrates a computer system 700 in which embodiments of the present disclosure, or portions thereof, may be implemented as computer-readable code. For example, the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for assigning a spend profile to a mobile device based on location and transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for assigning a spend profile to a mobile device based on location and transaction data, comprising:
storing, in a profile database, at least one spend profile, wherein each of the at least one spend profile includes a plurality of transaction data entries, each transaction data entry including data related to a payment transaction involving a common consumer and including at least a location identifier, transaction data, and timing information;
receiving, by a receiving device, a plurality of location data entries, wherein each location data entry includes data related to a mobile communication device and includes at least a geographic location of the related mobile communication device and a time and/or date at which the corresponding geographic location of the related mobile communication device was identified;
matching, by a processing device, the mobile communication device to a specific spend profile of the at least one spend profile based on
a number of received location data entries that correspond to transaction data entries included in the specific spend profile based on the geographic location and time and/or date included in the corresponding location data entry and the location identifier and timing information included in the corresponding transaction data entry, and
a predetermined tolerance level; and
associating, in a mobile information database, the mobile communication device with the specific spend profile.

2. The method of claim 1, further comprising:
identifying, by the processing device, at least one content item associated with the specific spend profile; and
transmitting, by a transmitting device, the at least one content item to the mobile communication device.

3. The method of claim 2, wherein the at least one content item is one of: an offer, a coupon, a reward, an advertisement, a discount, and a promotion.

4. The method of claim 1, wherein each spend profile further includes a plurality of characteristics based on at least the transaction data included in each of the plurality of transaction data entries included in the corresponding spend profile.

5. The method of claim 4, wherein the plurality of characteristics includes at least one of: spend behavior, propensity to spend, merchant preferences, geographic preferences, industry preferences, and transaction frequency.

6. The method of claim 4, further comprising:
storing, in a content database, a plurality of content items, wherein each content item is associated with a profile characteristic;
identifying, by the processing device, at least one content item of the plurality of content items where the associated profile characteristic is included in the plurality of characteristics included in the specific spend profile; and
transmitting, by a transmitting device, the at least one content item to the mobile communication device.

7. The method of claim 1, wherein the transaction data includes at least one of: merchant name, merchant category, merchant identifier, transaction amount, product data, and payment method.

8. The method of claim 1, further comprising:
storing, in a payment database, a plurality of payment data entries, wherein each payment data entry includes data related to a payment transaction including at least a consumer identifier, a location identifier, timing information, and transaction data;
identifying, by the processing device, a plurality of payment data entry subsets, wherein each payment data entry subset includes each payment data entry of the plurality of payment data entries including a common consumer identifier;
identifying, by the processing device, a group of payment data entry subsets based on common location identifiers and timing information included in the plurality of payment data entries included in each payment data entry subset of the group of payment data entry subsets; and
storing, in the profile database, the group of payment data entry subsets as a spend profile, wherein the plurality of transaction data entries includes at least one payment data entry subset included in the group of payment data entry subsets.

9. The method of claim 8, the group of payment data entry subsets is further based on common transaction data included in the plurality of payment data entries included in each payment data entry subset of the group of payment data entry subsets.

10. The method of claim 9, wherein the common transaction data includes at least one of: transaction amount and product data.

11. A system for assigning a spend profile to a mobile device based on location and transaction data, comprising:
a mobile information database;
a profile database configured to store at least one spend profile, wherein each of the at least one spend profile includes a plurality of transaction data entries, each transaction data entry including data related to a payment transaction involving a common consumer and including at least a location identifier, transaction data, and timing information;
a receiving device configured to receive a plurality of location data entries, wherein each location data entry includes data related to a mobile communication device and includes at least a geographic location of the related mobile communication device and a time and/or date at which the corresponding geographic location of the related mobile communication device was identified; and
a processing device configured to
match the mobile communication device to a specific spend profile of the at least one spend profile based on
a number of received location data entries that correspond to transaction data entries included in the specific spend profile based on the geographic location and time and/or date included in the corresponding location data entry and the location identifier and timing information included in the corresponding transaction data entry, and
a predetermined tolerance level, and
associate, in the mobile information database, the mobile communication device with the specific spend profile.

12. The system of claim 11, further comprising:
a transmitting device, and wherein
the processing device is further configured to identify at least one content item associated with the specific spend profile, and
the transmitting device is configured to transmit the at least one content item to the mobile communication device.

13. The system of claim 12, wherein the at least one content item is one of: an offer, a coupon, a reward, an advertisement, a discount, and a promotion.

14. The system of claim 11, wherein each spend profile further includes a plurality of characteristics based on at least the transaction data included in each of the plurality of transaction data entries included in the corresponding spend profile.

15. The system of claim 14, wherein the plurality of characteristics includes at least one of: spend behavior, propensity to spend, merchant preferences, geographic preferences, industry preferences, and transaction frequency.

16. The system of claim 14, further comprising:
a transmitting device; and
a content database configured to store a plurality of content items, wherein each content item is associated with a profile characteristic, wherein
the processing device is further configured to identify at least one content item of the plurality of content items where the associated profile characteristic is included in the plurality of characteristics included in the specific spend profile, and
the transmitting device is configured to transmit the at least one content item to the mobile communication device.

17. The system of claim 11, wherein the transaction data includes at least one of: merchant name, merchant category, merchant identifier, transaction amount, product data, and payment method.

18. The system of claim 11, further comprising:
a payment database configured to store a plurality of payment data entries, wherein each payment data entry includes data related to a payment transaction including at least a consumer identifier, a location identifier, timing information, and transaction data, wherein
the processing device is further configured to
identify a plurality of payment data entry subsets, wherein each payment data entry subset includes each payment data entry of the plurality of payment data entries including a common consumer identifier,
identify a group of payment data entry subsets based on common location identifiers and timing information included in the plurality of payment data entries included in each payment data entry subset of the group of payment data entry subsets, and
store, in the profile database, the group of payment data entry subsets as a spend profile, wherein the plurality of transaction data entries includes at least one payment data entry subset included in the group of payment data entry subsets.

19. The system of claim 18, the group of payment data entry subsets is further based on common transaction data included in the plurality of payment data entries included in each payment data entry subset of the group of payment data entry subsets.

20. The system of claim 19, wherein the common transaction data includes at least one of: transaction amount and product data.
